(19) United States
(12) Patent Application Publication
(10) Pub. No.: US 2024/0250314 A1
(43) Pub. Date: Jul. 25, 2024

(54) Electrochemical System Suppressing H2 Bubble Formation on Electrified Pt Electrode in Water-in-salt Electrolyte Solution

(71) Applicant: IUCF-HYU (Industry-University Cooperation Foundation Hanyang University), Seoul (KR)

(72) Inventors: Jinho Chang, Seoul (KR); Cheolmin Park, Seoul (KR)

(21) Appl. No.: 18/462,666

(22) Filed: Sep. 7, 2023

(30) Foreign Application Priority Data
Sep. 7, 2022 (KR) 10-2022-0113754

(51) Int. Cl. H01M 10/42; C25B 1/04; C25B 15/02; H01M 4/38; H01M 4/92; H01M 8/08; H01M 8/18; H01M 10/36

(52) U.S. Cl. CPC H01M 10/4235; C25B 1/04; C25B 15/02; H01M 4/38; H01M 4/92; H01M 8/08; H01M 8/188; H01M 10/36; H01M 2300/0002

(57) ABSTRACT

An electrochemical system is provided including a Pt electrode and a water-in-salt electrolyte solution and induces a redox reaction of hydrogen gas by applying a negative potential to the Pt electrode, wherein the water-in-salt electrolyte solution includes an aqueous solvent and an salt, wherein the salt includes lithium bis(trifluoromethanesulfonyl)imide (LiTFSI), lithium trifluoromethane sulfonate (LiOTf), lithium bis(fluorosulfonyl)imide (LiFSI), lithium bis(pentafluoroethane sulfonyl)imide (LiBETI), or a combination thereof, and a molal concentration of the water-in-salt electrolyte is 5 m to 50 m, to suppress formation of hydrogen gas bubbles on the Pt electrode to which the negative potential is applied.

### CROSS-REFERENCE TO RELATED APPLICATION

This application claims priority to Korean Patent Application No. 10-2022-0113754, filed on Sep. 7, 2022, in the Korean Intellectual Property Office, and all the benefits accruing therefrom under 35 U.S.C. § 119, the entire contents of which is incorporated herein by reference.

### BACKGROUND OF THE INVENTION

### (a) Field of the Invention

This relates to an electrochemical system in which bubble formation on a Pt electrode in a water-in-salt electrolyte solution is suppressed and a reversible redox reaction of hydrogen gas is induced.

### (b) Description of the Related Art

Research on an electrochemical redox reaction of hydrogen gas (H₂) in an aqueous electrolyte system is being extensively conducted. However, the hydrogen gas has low solubility in an aqueous solvent and so exists in a bubble state rather than in a hydrated state by being dissolved therein and thus generates a large amount of gas bubbles on the electrode surface, which acts as a main factor inhibiting a reaction rate of the electrochemical system.

### SUMMARY OF THE INVENTION

A method is provided to effectively suppress bubble formation by increasing a solubility of hydrogen gas on an electrode surface to which an electric potential is applied, thereby inducing a reversible redox reaction of hydrogen gas.

In an embodiment, an electrochemical system is provided that includes a Pt electrode and a water-in-salt electrolyte solution wherein the electrochemical system induces a redox reaction of hydrogen gas by applying a negative potential to a Pt electrode, and formation of hydrogen gas bubbles is successfully suppressed on the Pt electrode to which the negative potential is applied. The water-in-salt electrolyte solution includes an aqueous solvent and a salt, and the salt includes lithium bis(trifluoromethanesulfonyl)imide (LiTFSI), lithium trifluoromethane sulfonate (LiOTf), lithium bis(fluorosulfonyl)imide (LiFSI), lithium bis(pentafluoroethane sulfonyl)imide (LiBETI), or a combination thereof, and a molal concentration of the water-in-salt electrolyte solution is 5 m to 50 m.

According to an embodiment, the solubility of hydrogen gas increases at the interface of the Pt electrode to which a potential is applied, thereby effectively suppressing the bubble formation, and thereby increasing the reversibility of the oxidation-reduction reaction of hydrogen gas.

### BRIEF DESCRIPTION OF THE DRAWINGS

FIG. 1A is a cyclic voltammetry (CV) graph for Pt MDE of Comparative Example 1, FIGS. 1B1 and 1B2 are each a CV graph for Pt UME of Comparative Example 1, FIG. 1C is a CV graph for Pt MDE of Example 1, and FIG. 1D is a CV graph for Pt UME of Example 1.

FIG. 2A is a CV graph of Example 2, FIG. 2B is a CV graph of Comparative Example 2, and FIG. 2C is a CV graph of Comparative Example 3. FIGS. 2D and 2E are iₚₐ/i_{pc} graphs for Examples 1 and 2 and Comparative Examples 2 and 3. FIG. 2F shows K_{app,H2 bubble} histograms for Examples 1 and 2 and Comparative Examples 2 and 3.

FIGS. 3A and 3B are each a snapshot over time of the formation of H₂ bubbles during electrode-reduction of H⁺ at the Pt MDE to which a potential of −0.7 V is applied: FIG. 3A is a photograph of Comparative Example 3 of 6 m of LiCl, and FIG. 3B is a photograph of Example 1 of 6 m of LiTFSI.

FIGS. 4A to 4D are graphs showing frequency changes over time measured through EQCM analysis in Examples 1 and 2 and Comparative Examples 1 to 3. FIG. 4E is a diagram schematically showing the hydrogen bubble formation mode according to various electrolyte types measured through EQCM.

FIG. 5 is a graph showing the frequency change over time when 6 m of LiTFSI and 9 m of LiTFSI are applied.

FIGS. 6A to 6D are CV graphs of Example 1, Example 2, Comparative Example 3, and Comparative Example 2 in that order. FIG. 6E is a diagram schematically showing the electrode-oxidation reaction of H₂ occurring at the IFL of the Pt electrode in 6 m of LiTFSI salt-in-salt water. FIG. 6F is a graph showing C_{d} before and after 10 cycles in the electrolyte solutions of Examples 1 and 2 and Comparative Examples 2 and 3.

FIGS. 7A and 7B are each a graph showing the measured capacitance (C_{d}) as a function of electrode potential referring to Ag/AgCl on a Pt MDE in 6 m LiTFSI and LiOTf solutions, respectively, without the addition of HClO₄.

FIG. 8A is a CV graph of Comparative Example 4. FIG. 8B is a graph showing the change in frequency over time by measuring EQCM at different concentrations of 3 m, 4 m, 5 m, and 6 m LiTFSI in Comparative Example 4. FIG. 8C is a CV graph when applying the 6 m of LiTFSI electrolyte solution without HClO₄ and before and after applying −1 V while injecting H₂ in Comparative Example 4. FIG. 8D is a diagram schematically showing the different H₂ electrode-oxidation mechanisms seen in each of the Pt electrode and Au electrode.

### DETAILED DESCRIPTION OF THE EMBODIMENTS

Hereinafter, embodiments of the present invention are described in detail so that those of ordinary skill in the art can easily implement the present invention. However, this disclosure may be embodied in many different forms and is not construed as limited to the example embodiments set forth herein.

Hereinafter, “combination thereof” refers to a mixture, a laminate, a composite, a copolymer, an alloy, a blend, or a reaction product of constituents.

Herein, it should be understood that terms such as “comprises,” “includes,” or “have” are intended to designate the presence of an embodied feature, number, step, element, or a combination thereof, and it does not preclude the possibility of the presence or addition of one or more other features, number, step, element, or a combination thereof.

In the drawings, the thickness of layers, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present. “Layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

In an embodiment, an electrochemical system includes a Pt electrode and a salt-in-water electrolyte solution and induces an oxidation-reduction reaction of hydrogen gas by applying a negative potential to the Pt electrode, whereby the bubble formation of hydrogen gas on a Pt electrode to which a negative potential is applied is successfully suppressed to provide an electrochemical system capable of inducing a reversible oxidation-reduction reaction of hydrogen gas. The water-in-salt electrolyte solution includes an aqueous solvent and a salt, and the salt includes lithium bis(trifluoromethanesulfonyl)imide (LiTFSI), lithium trifluoromethane sulfonate (LiOTf), lithium bis(fluorosulfonyl)imide (LiFSI), lithium bis(pentafluoroethane sulfonyl)imide (LiBETI), or a combination thereof, and a molal concentration of the water-in-salt electrolyte is 5 m to 50 m.

The aqueous solvent of the water-in-salt electrolyte solution may include water, an alcohol-based solvent, or a combination thereof, and may, for example, refer to a solvent including 80 volume % or more of water.

The molal concentration of the water-in-salt electrolyte is 5 m to 50 m, for example, may be 5 m to 40 m, 5 m to 30 m, 5 m to 20 m, 5 m to 15 m, or 6 m to 50 m. When the above concentration range is satisfied, bubble formation on the surface of the Pt electrode is suppressed and a reversible oxidation-reduction reaction of hydrogen gas can be effectively induced.

Research on the electrochemical oxidation-reduction reaction of hydrogen gas (H₂) in an aqueous electrolyte system is being conducted extensively. However, in aqueous solvents, hydrogen gas exists in a bubble state rather than being dissolved in a hydrated state. Therefore, the solubility of hydrogen gas in an aqueous solution including 1 M NaCl at normal pressure is only about 0.6 mM. On the other hand, in an embodiment, by adding a compound that is a raw material for hydrogen gas to a specific water-in-salt electrolyte solution and applying a negative potential to the Pt electrode, the properties of the Pt electrode surface are changed so that hydrogen gas is stabilized in a dissolved state rather than forming bubbles. Accordingly, it is possible to enable a reversible oxidation-reduction reaction of hydrogen gas on the Pt electrode surface and to improve the speed of the oxidation-reduction reaction.

Herein, the electrochemical system may be expressed as an electrochemical device, and may be, for example, a fuel cell, a hydrogen storage system, an electrode analysis system, an electrolysis device, a redox flow battery, a capacitor, or a rechargeable battery, but is not limited thereto.

The compound that serves as a raw material for hydrogen gas may be, for example, an acidic solution such as HClO₄.

The voltage range applied to the Pt electrode may be, for example, −0.1 V to −1.0 V.

### EXAMPLES

### 1. Cyclic Voltammetry Analysis of Hydrogen Formation Reaction According to Type of Electrolyte

### Comparative Example 1

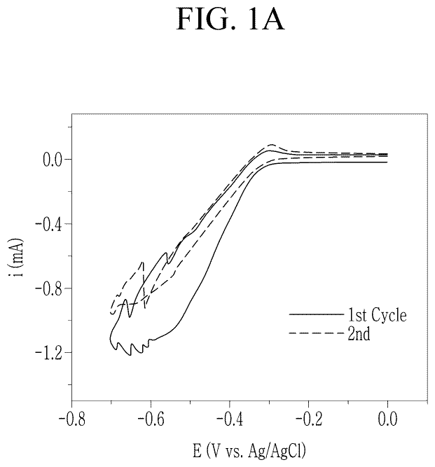

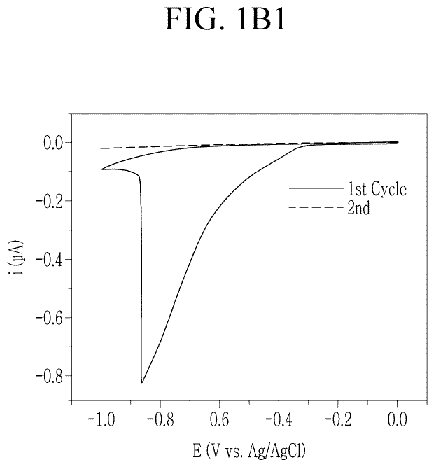

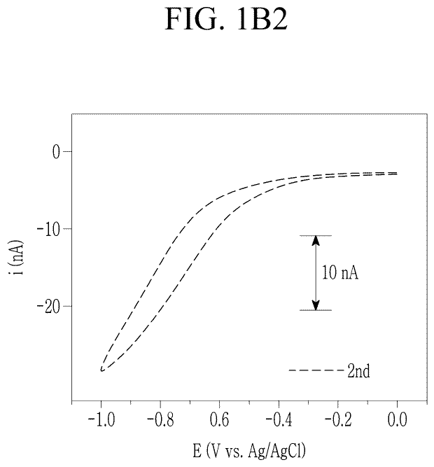

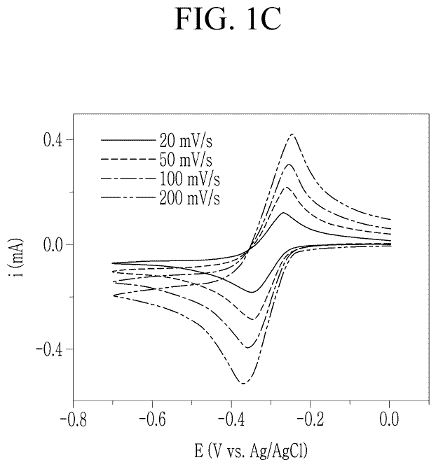

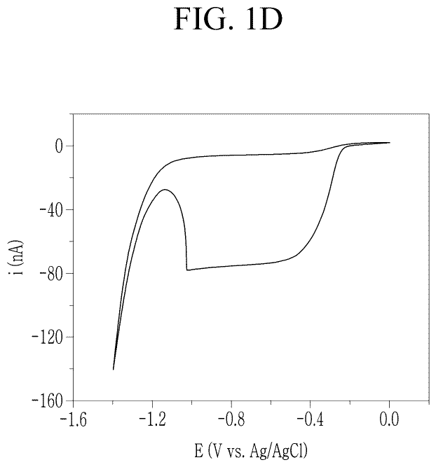

An electrochemical cell according to Comparative Example 1 was manufactured by using a Pt macro disk electrode (MDE) as a working electrode, Ag/AgCl (1 M KCl) as a reference electrode, a Pt wire as a counter electrode, and an acidic solution prepared by adding 50 mM of HClO₄ to distilled water as a basic electrolyte solution. FIG. 1A is a CV graph showing first and second cycles of the cell for a hydrogen evolution reaction (HER) in the Pt MDE of Comparative Example 1. Since H₂ bubbles generated on the electrode surface made the surface unstable, a current containing a noise signal due to the unstable surface is observed. In addition, Comparative Example 1 exhibited almost no hydrogen oxidation-reduction peak on the Pt MDE surface, which confirms that the H₂ bubbles were rapidly produced under this electrolyte solution condition.

Subsequently, the working electrode was changed to a Pt ultramicro electrode (UME) to manufacture an electrochemical cell, of which CV graphs showing the first and second cycles are shown in FIGS. 1B1 and 1B2. When a hydrogen evolution reaction (HER) occurs at a Pt UME, a current rapidly decreases, before a reduction peak appears, because a reaction region is limited, as H₂ bubbles generated on the electrode surface block the electrode. FIGS. 1B1 and 1B2 confirms that about 88% of the surface of the Pt UME was blocked by the H₂ bubbles and accordingly, that there was almost no oxidation-reduction peak of H₂.

### Example 1

An electrochemical cell according to Example 1 was manufactured substantially in the same manner as in Comparative Example 1 except that a “Water-in-LiTFSI” electrolyte solution prepared by adding 6 m of LiTFSI to the basic electrolyte solution was used. FIG. 1C shows a CV graph at a scan rate of 20, 50, 100, and 200 mV/s of Example 1. In Example 1, a current having less noise signal than that of Comparative Example 1 was observed, and a hydrogen oxidation-reduction peak was also confirmed.

In addition, referring to FIG. 1C, a ratio (iₚₐ/i_{pc}) of an anode voltage-based peak current (iₚₐ) to a cathode voltage-based peak current (i_{pc}) at all the scan rates was calculated to be about 1. This means that the H⁺/H₂ oxidation-reduction reaction is completely reversible and also, that electrically formed H₂ may exist in a dissolved state in the electrolyte solution rather than as bubbles.

Subsequently, the working electrode was changed to Pt UME to manufacture an electrochemical cell, and a CV graph thereof is shown in FIG. 1D. Referring to FIG. 1D, compared with Comparative Example 1 to which LiTFSI was not added, Example 1 to which 6 m of LiTFSI was added exhibited no sudden current decrease, which confirms that the H₂ bubble formation was suppressed.

Referring to the results of FIGS. 1A to 1D, when the water-in-salt electrolyte solution prepared by applying 6 m of LiTFSI was applied, the H₂ bubble formation on the Pt electrode surface by HER was effectively suppressed, which confirms that a reversible H⁺/H₂ oxidation-reduction reaction was successfully induced on the Pt electrode surface.

Such an effect may vary depending on types of an electrolyte solution, which may be confirmed through Example 2 and Comparative Examples 2 and 3 below.

### Example 2

An electrochemical cell was manufactured substantially in the same manner as in Example 1 except that 6 m of LiOTf was used instead of 6 m of LiTFSI.

### Comparative Example 2

An electrochemical cell was manufactured substantially in the same manner as in Example 1 except that 6 m of LiNO₃ was used instead of 6 m of LiTFSI.

### Comparative Example 3

An electrochemical cell was manufactured substantially in the same manner as in Example 1 except that 6 m of LiCl was used instead of 6 m of LiTFSI.

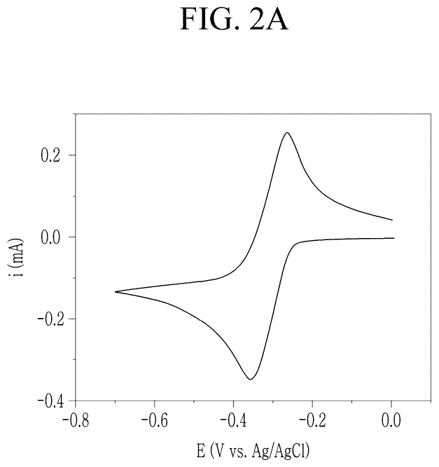

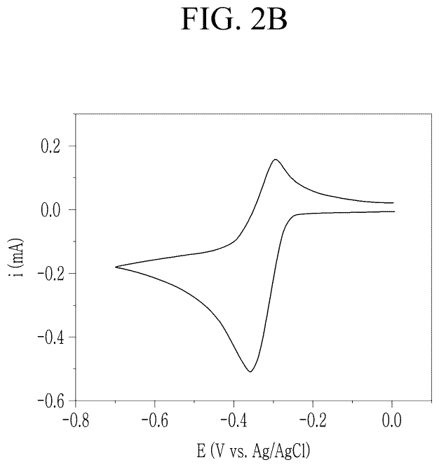

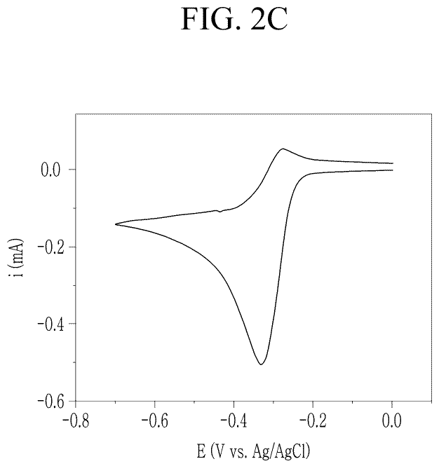

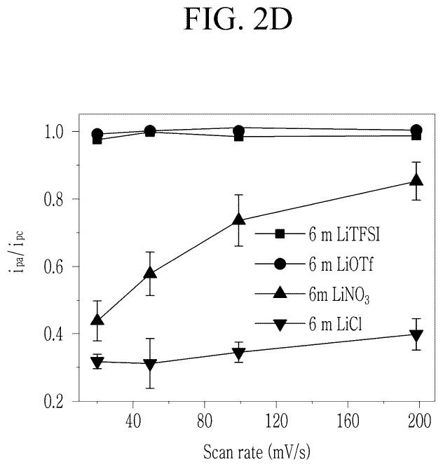

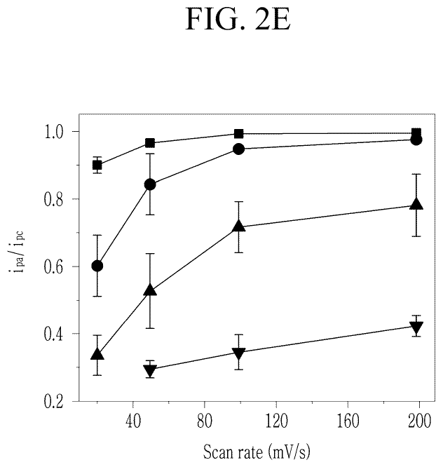

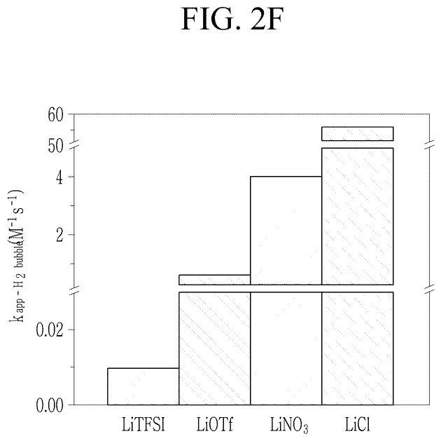

FIG. 2A is a CV graph at 50 mV/s of Example 2, FIG. 2(b) is a CV graph at 50 mV/s of Comparative Example 2, and FIG. 2C is a CV graph at 50 mV/s of Comparative Example 3. In FIG. 2A, iₚₐ/i_{pc} of Example 2 was calculated to be about 1, which means that the H⁺/H₂ oxidation-reduction reaction was completely reversible. On the contrary, in FIG. 2B, Comparative Example 2 using 6 m of LiNO₃ exhibited that iₚₐ/i_{pc} decreased down to about 0.6, and in FIG. 2C, Comparative Example 3 using 6 m of LiCl exhibited that iₚₐ/i_{pc} decreased down to about 0.3, which confirms that the oxidation-reduction reaction was irreversible.

FIGS. 2D and 2E show iₚₐ/i_{pc} changes according to various scan rates, which were measured for the electrochemical cells of Examples 1 and 2 and Comparative Examples 2 and 3. FIG. 2D is a case of adding 50 mM of HClO₄, and FIG. 2E is a case of adding 100 mM of HClO₄. Referring to FIGS. 2D and 2E, Examples 1 and 2 exhibited a completely reversible oxidation-reduction reaction at all the scan rates, but Comparative Examples 2 and 3 exhibited an irreversible oxidation-reduction reaction at all the scan rates.

FIG. 2F shows forward reaction constant (K_{app,H2 bubble}) histograms of Reaction Scheme 1 for the electrochemical cells of Examples 1 and 2 and Comparative Examples 2 and 3.

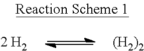

Referring to FIG. 2F, Example 1 exhibited the constant of about 0.01 M⁻¹s⁻¹, which confirms that the H₂ bubble formation was mechanically well suppressed.

According to an embodiment, in the acidic solutions of 6 m of LiTFSI and 6 m of LiOTf, the H₂ bubble formation was suppressed, thereby increasing solubility of hydrogen therein, securing a reversible H⁺/H₂ oxidation reduction reaction, and improving a reaction rate, but in the 6 m of LiNO₃ and 6 m of LiCl electrolytes, there was almost no reversible oxidation-reduction behavior, which was confirmed through voltammetry.

### 2. Monitoring Hydrogen Bubble Formation Through EQCM

Below, whether or not the H₂ bubble formation was mechanically suppressed during the electrode-reduction of H⁺ at a Pt electrode was monitored through EQCM (electrochemical quartz crystal microbalance) in a macroscopic method. In order to analyze the EQCM, an electrochemical cell was manufactured by using Pt as an working electrode, a stainless steel rod as a counter electrode, and Ag/AgCl (1 M KCl) as a reference electrode, and as in Examples 1 and 2 and Comparative Examples 2 and 3, used was an electrolyte solution prepared by respectively adding 6 m of LiTFSI, LiOTf, LiNO₃, and LiCl to a basic electrolyte solution, which was prepared by dissolving 50 mM of HClO₄ in distilled water.

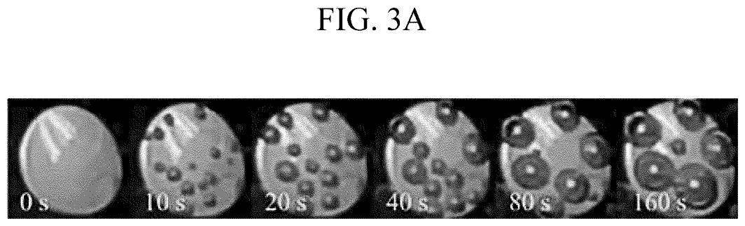

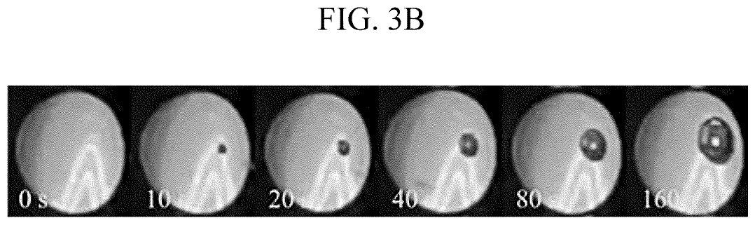

FIGS. 3A and 3B are each a snapshot over time taking the H₂ bubble formation during electrode-reduction of H⁺ at the Pt MDE to which a potential of −0.7 V was applied. FIG. 3A is a photograph of Comparative Example 3 including 6 m of LiCl, and FIG. 3B is a photograph of Example 1 including 6 m of LiTFSI. FIG. 3A shows that lots of H₂ bubbles were formed on the entire Pt electrode surface, and after 160 seconds, the bubbles grew larger and covered the electrode surface. On the contrary, referring to FIG. 3B, after 10 seconds, only one bubble was locally formed with no other bubbles, which confirms that the bubble formation was surely suppressed, compared with FIG. 3A.

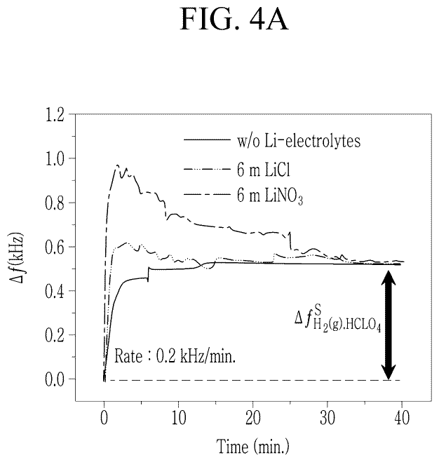

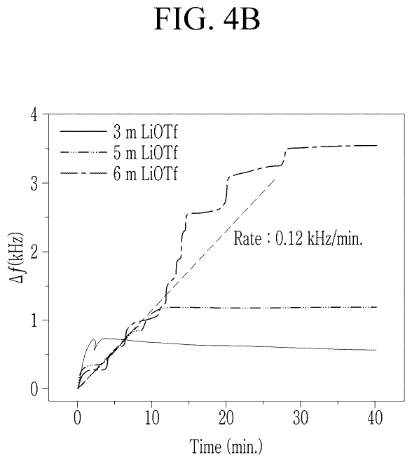

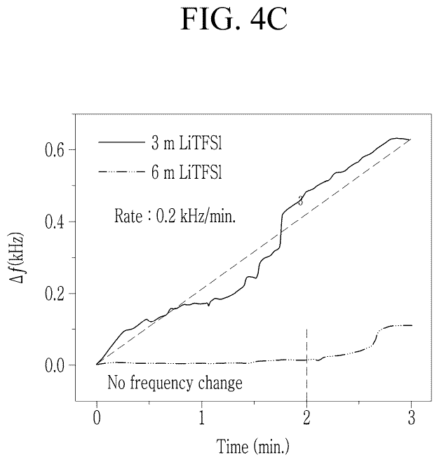

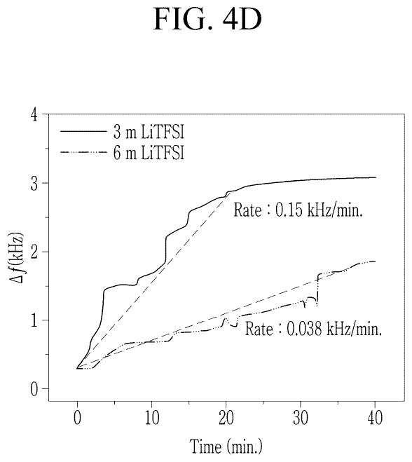

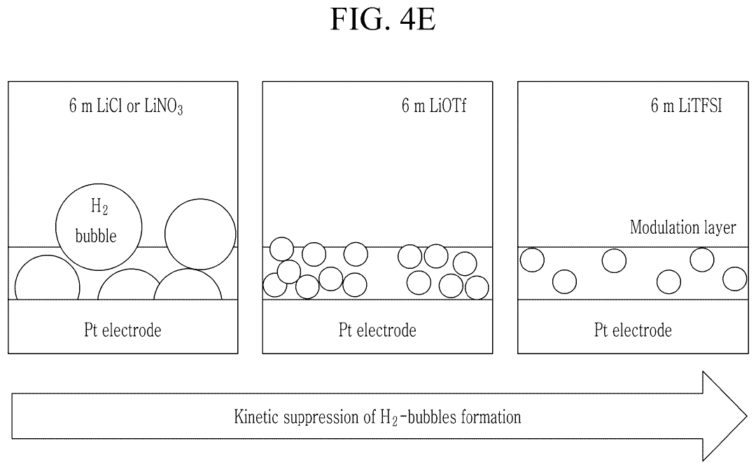

Below, bubble formation characteristics of the electrolytes at various concentrations were analyzed through the EQCM. Frequency changes (Δf) over time were measured during the electrode-reduction of H⁺ at the Pt electrode by applying −0.6 V of a potential, and the results are shown in FIGS. 4A to 4D. Herein, it is known that a frequency increase according to the hydrogen bubble formation is mainly due to replacement of liquid with gas mainly in an interfacial layer modified on the electrode surface. Accordingly, in FIG. 4A, referring to a line indicated as without (w/o) Li-electrolytes, corresponding to Comparative Example 1 to which a lithium salt was not added, a Δ f curve shows that hydrogen bubbles were rapidly formed and surrounded the Pt electrode surface and eventually, completely covered the entire electrode surface. In FIG. 4A, Comparative Example 3 using 6 m of LiCl and Comparative Example 2 using 6 m of LiNO₃ exhibited a higher initial H₂ generation rate than Comparative Example 1 but eventually converged as shown in the graph of Comparative Example 1. This indicates that the electrodes of Comparative Examples 2 and 3 were covered with H₂ within a similar range.

FIG. 4B is a graph showing frequency changes over time when LiOTf at various molal concentrations of 3 m, 5 m, and 6 m was applied. When 3 m of LiOTf was applied, a similar result to 6 m of LiCl or 6 m of LiNO₃ was obtained. When LiOTf was included at a concentration of 5 m or more, Δf increased and then, converged at Δf_{H2(g)}^{s}=1.18 KHz. When LiOTf was included at a concentration of 6 m, Δf_{H2(g)}^{s} increased to 3.57 kHz, which is approximately 7 times that of 3 m of LiOTf.

FIGS. 4C and 4D are graphs of Δf over time when 3 m of LiTFSI and 6 m of LiTFSI were applied: FIG. 4C is the result for a short time of less than 3 minutes and FIG. 4D is the result for a long time of about 40 minutes. When 3 m of LiTFSI was applied, Δf/Δt was calculated to be 0.20 KHz/min in the short time region and 0.15 kHz/min in the long time region, which confirms that hydrogen bubbles were less formed than a case of adding no lithium salt. When the concentration of LiTFSI was increased to 6 m, there was almost no frequency change according to the hydrogen bubble formation in the short time region of 2 minutes, but even after 2 minutes, as the frequency slightly increased, an overall hydrogen bubble formation rate was calculated to be about 0.038 kHz/min, which is four times that of 3 m of LiTFSI. This means that the hydrogen bubble formation was effectively suppressed by HER in 6 m of LiTFSI. FIG. 4E schematically shows a hydrogen bubble formation mode according to various types of electrolytes through EQCM.

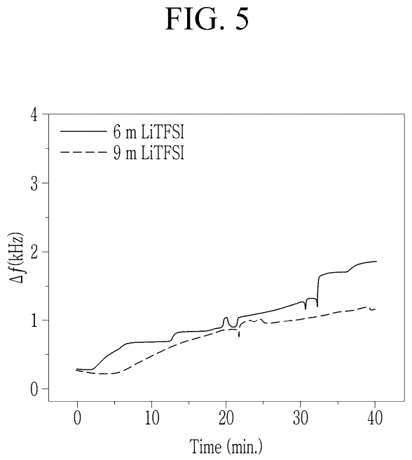

Furthermore, Δf change over time was measured in 9 m of LiTFSI, which is shown in FIG. 5. Referring to FIG. 5, the hydrogen bubble formation was further suppressed at the concentration of 9 m, and Δf up to 5 minutes was almost close to 0.

### 3. Interaction Between H₂ and Electrode Interfacial Layer (IFL)

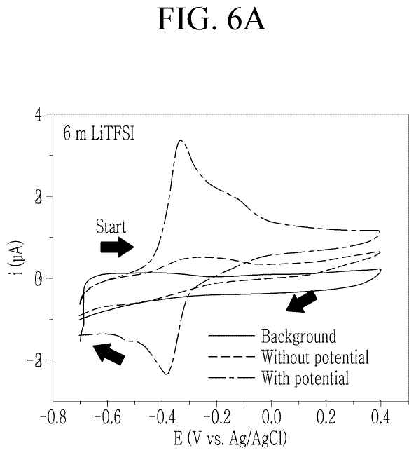

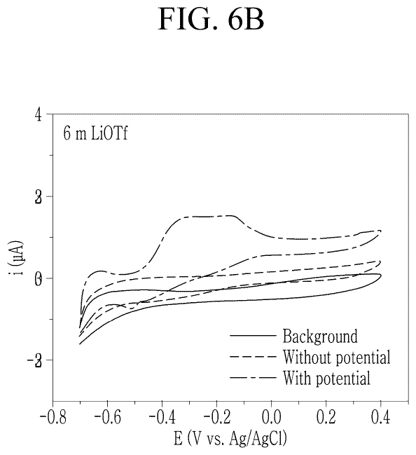

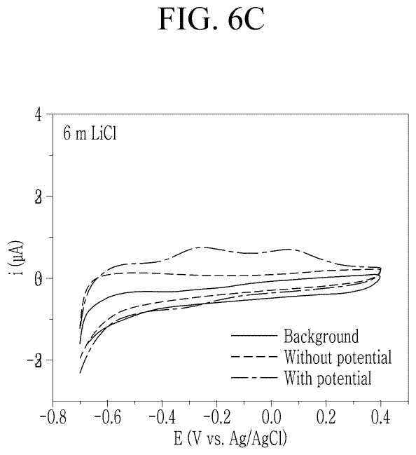

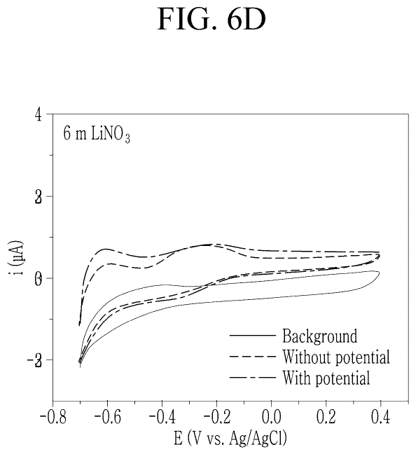

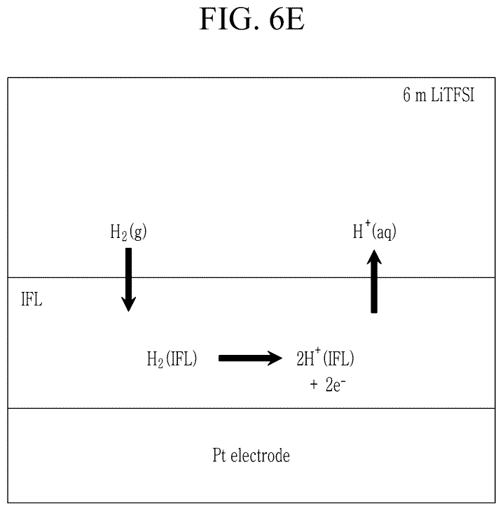

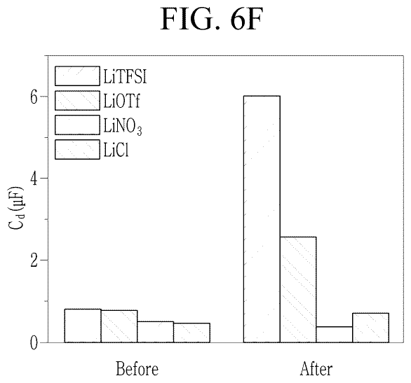

The same electrochemical cells as in Examples 1 and 2 and Comparative Examples 2 and 3 were manufactured without adding HClO₄. These cells correspond to lines indicated as background in graphs of FIGS. 6A to 6D. Each cell was measured with respect to CV within a range of −0.7 V to 0.4 V by injecting H₂ gas into an electrolyte solution for 20 minutes but maintaining an open circuit (lines indicated as without potential in graphs of FIGS. 6A to 6D) or applying −0.7 V (lines indicated as with potential in graphs of FIGS. 6A to 6D), and the results are shown in FIGS. 6A to 6D. FIG. 6A corresponds to Example 1 of 6 m of LiTFSI, FIG. 6B corresponds to Example 2 of 6 m of LiOTf, FIG. 6C corresponds to Comparative Example 3 of 6 m of LiCl, and FIG. 6D corresponds to Comparative Example 2 of 6 m of LiNO₃.

Referring to FIGS. 6A to 6D, a fine oxidation peak alone appeared in a state of not applying a negative potential (lines indicated as without potential), which was similar to a CV graph of a case of injecting no H₂ (lines indicated as background). The reason is that solubility of H₂ is low even in an electrolyte solution at a high concentration. On the contrary, the case of applying −0.7 V with the injection of H₂ (lines indicated as with potential) clearly exhibited a peak according to an electrode-oxidation reaction of H₂ to H⁺ in each CV graph of the LiTFSI electrolyte solution and the LiOTf electrolyte solution and also, twice more current in LiTFSI than in LiOTf. On the other hand, each LiCl and LiNO₃ electrolyte solution exhibited almost the same result as a case of applying no potential. The reason is that only when the LiTFSI and LiOTf electrolyte solutions at a high concentration were applied, H₂ was stabilized in a dissolved state by the electrode to which the potential was applied.

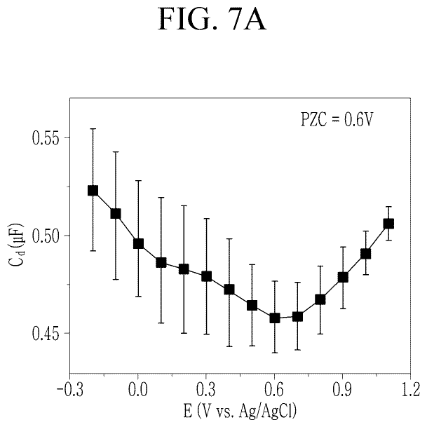

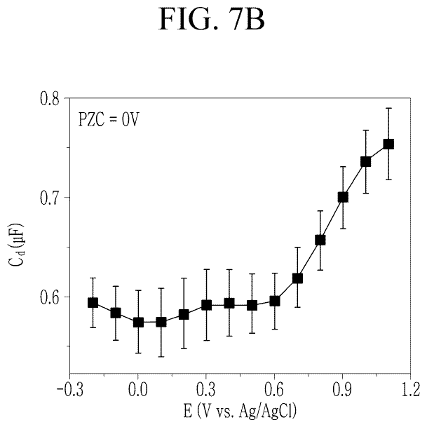

FIGS. 7A and 7B are each a graph showing the measured capacitance (C_{d}) as a function of electrode potential referring to Ag/AgCl on a Pt MDE in 6 m LiTFSI, and LiOTf solutions, respectively, without the addition of HClO₄. Referring to FIGS. 7A and 7B, PZC (point of zero charge) of Pt in each LiTFSI and LiOTf electrolyte solution was respectively 0.6 V and 0 V. Accordingly, in the two electrolyte solutions, a negative potential was applied to the Pt electrode during the H⁺/H₂ oxidation-reduction reaction, forming an interfacial layer (IFL) on the electrode surface to which the negative potential was applied. In addition, the IFL had an intermediate phase of 0 V and −2 V (vs. PZC) during the HER, which is understood to include a mixture of anions (TFSI⁻ or OTf⁻) and cations ([Li(H₂O)ₙ]⁺). FIG. 6E schematically shows an electrode-oxidation reaction of H₂ on the IFL of the Pt electrode in 6 m of LiTFSI water-in-salt.

If H₂ strongly interacts with the IFL, H₂ takes a space on the layer, eventually forming a porous ion network structure in the IFL. This may be proved by measuring C_{d} in the 6 m of electrolyte solutions of Examples 1 and 2 and Comparative Examples 2 and 3 at 0 V and after performing CV for the hydrogen oxidation-reduction reaction at 20 mV/s for 10 cycles, remeasuring C_{d}. FIG. 6F shows C_{d} before and after the 10 cycles in each electrolyte solution. Referring to FIG. 6F, before the cycles, the different electrolyte solutions exhibited similar C_{d}, but after the 10 cycles, the LiTFSI electrolyte solution exhibited 6 times increased C_{d}, and the LiOTf electrolyte solution almost twice increased C_{d}. These C_{d} increases after the hydrogen oxidation-reduction reaction mean that the surface areas of the electrode increased to accumulate charges, to which the formation of the porous IFL mainly contributed. Such IFL is distinguished from SEI formed by decomposition of TFSI⁻ and the like.

Ultimately, in the electrochemical system according to an embodiment, an ionic interfacial layer may be said to be formed on the surface of a Pt electrode to which a negative potential is applied. The ionic interfacial layer may be a layer that exists only when a voltage is applied or a potential difference occurs but disappears when the potential difference disappears. The ionic interfacial layer may include anions and cations, for example, the ionic interfacial layer may be one in which the anions and cations derived from the salts (LiTFSI, LiOTf, etc.) are ordered, and accordingly, water molecules, a solvent in the ionic interfacial layer, withdraw from the ionic interfacial layer. In the ionic interfacial layer formed on the Pt electrode surface, the oxidation-reduction reaction of hydrogen gas may occur, which suppresses bubble formation of the hydrogen gas.

### 4. Voltammetry and EQCM Analysis of Au Electrodes

### Comparative Example 4

An electrochemical cell was manufactured in the same manner substantially as in Example 1 except that Au MDE was used instead of the Pt MDE as the working electrode.

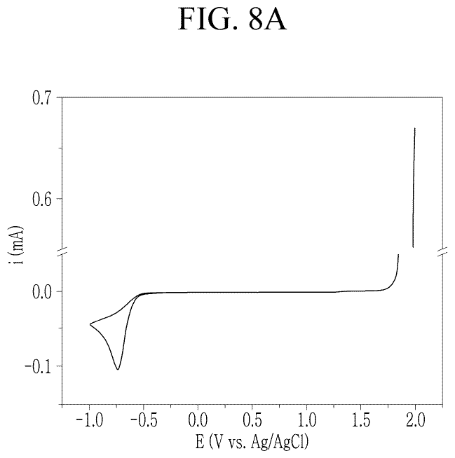

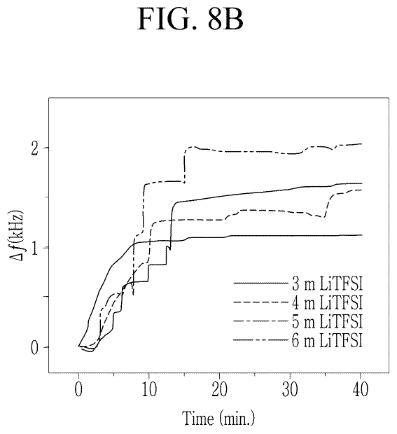

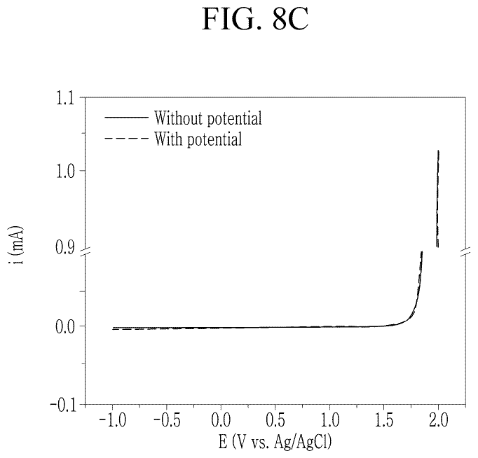

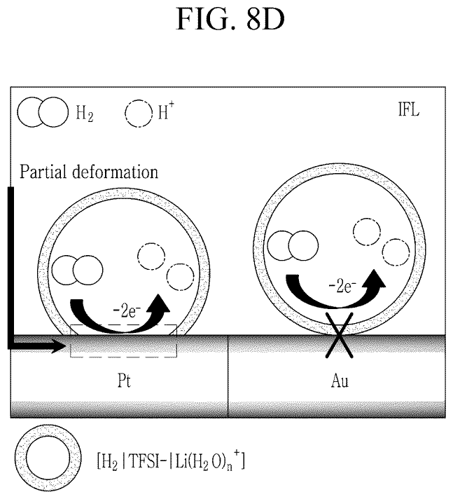

FIG. 8A is a CV graph of Comparative Example 4. Referring to FIG. 8A, a peak related to an electrode-reduction of H⁺ to H₂ in the forward scan appeared at −0.73 V, which was lower by −0.38 V than Example 1, and in addition, charge transfer became slower than Example 1. In the reverse direction scan of FIG. 8A, there was no peak related to an electrode-oxidation of H₂.

After measuring EQCM by changing a concentration of LiTFSI to 3 m, 4 m, 5 m, and 6 m in Comparative Example 4, a Δf graph over time is shown in FIG. 8B. The result of FIG. 8B is similar to that of LiOTf, which shows that hydrogen bubbles were not rapidly generated at the Au electrode.

It is known that for the electrode-oxidation of H₂ at Au to occur, H₂ must be first adsorbed on the Au surface. In the 6 m of LiTFSI electrolyte solution, since Au had PZC (vs. Ag/AgCl) of about 1 V, IFL may be regarded to be formed on the Au surface during the reduction process of H⁺. Accordingly, IFL on the Au surface may be considered to have difficulties in absorbing H₂. In order to analyze this, after preparing a 6 m of LiTFSI electrolyte solution to which HClO₄ was not added, CV was performed by applying −1 V, while injecting H₂, and the result is shown in FIG. 8C. In FIG. 8C, there was no electrode-oxidation peak of H₂. Accordingly, H₂ might be stabilized by IFL on the Au surface but was significantly hindered from adsorption onto the Au surface, and as a result, the oxidation-reduction reaction of H⁺/H₂ is understood to be irreversible. FIG. 8D schematically shows each different H₂ electrode-oxidation mechanism at the Pt electrode and the Au electrode.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. An electrochemical system, comprising
a Pt electrode and a water-in-salt electrolyte solution, wherein the electrochemical system induces a redox reaction of hydrogen gas by applying a negative potential to a Pt electrode,
the water-in-salt electrolyte solution includes an aqueous solvent and a salt, the salt includes lithium bis(trifluoromethanesulfonyl)imide (LiTFSI), lithium trifluoromethane sulfonate (LiOTf), lithium bis(fluorosulfonyl)imide (LiFSI), lithium bis(pentafluoroethane sulfonyl)imide (LiBETI), or a combination thereof, a molal concentration of the water-in-salt electrolyte solution is 5 m to 50 m, and
formation of hydrogen gas bubbles is suppressed on the Pt electrode to which the negative potential is applied.

2. The electrochemical system of claim 1, wherein
the salt of the water-in-salt electrolyte solution is lithium bis(trifluoromethanesulfonyl)imide (LiTFSI).

3. The electrochemical system of claim 1, wherein
a molal concentration of the water-in-salt electrolyte solution is 6 m to 20 m.

4. The electrochemical system of claim 1, wherein
an ionic interfacial layer is formed on the surface of a Pt electrode to which a negative potential is applied.

5. The electrochemical system of claim 4, wherein
the ionic interfacial layer exists only when a voltage is applied or a potential difference occurs.

6. The electrochemical system of claim 4, wherein
in the ionic interfacial layer, anions and cations of the salt are ordered.

7. The electrochemical system of claim 4, wherein
an oxidation reaction of the hydrogen gas occurs in the ionic interfacial layer, thereby suppressing bubble formation of the hydrogen gas.

8. The electrochemical system of claim 1, wherein
a negative potential of −0.1 V to −1.0 V is applied to the Pt electrode.

9. The electrochemical system of claim 1, wherein
the electrochemical system is a fuel cell, a hydrogen storage system, an electrode analysis system, an electrolysis device, a redox flow cell, a capacitor, or a rechargeable battery.

10. A method of suppressing formation of hydrogen gas bubbles on a Pt electrode to which a negative potential is applied and inducing a reversible oxidation-reduction reaction of hydrogen gas, comprising
preparing an electrochemical device including raw materials of Pt electrode, a water-in-salt electrolyte solution, and hydrogen gas,
wherein the water-in-salt electrolyte solution includes an aqueous solvent and a salt, and the salt includes lithium bis(trifluoromethanesulfonyl)imide (LiTFSI), lithium trifluoromethane sulfonate (LiOTf), lithium bis(fluorosulfonyl)imide (LiFSI), lithium bis(pentafluoroethane sulfonyl)imide (LiBETI), or a combination thereof, and a molal concentration of the water-in-salt electrolyte is 5 m to 50 m, and
applying a negative potential to the Pt electrode,
to suppress formation of hydrogen gas bubbles on a Pt electrode to which a negative potential is applied and to induce a reversible oxidation-reduction reaction of hydrogen gas.
